(19) United States
(12) Patent Application Publication
(10) Pub. No.: US 2005/0080761 A1
(43) Pub. Date: Apr. 14, 2005

(54) Data path media security system and method in a storage area network

(75) Inventors: Kumar Sundararajan, Fremont, CA (US); Upendra Mardikar, San Jose, CA (US); Richard Moeller, San Jose, CA (US); Soummya Mallick, Fremont, CA (US); Rainer Enders, Walnut Creek, CA (US); Sanjay Sawhney, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NeoScale Systems, Milpitas, CA (US)

(21) Appl. No.: 10/686,550

(22) Filed: Oct. 14, 2003

Related U.S. Application Data
(60) Provisional application No. 60/419,658, filed on Oct. 18, 2002.

(51) Int. Cl. G06F 7/00

(52) U.S. Cl. 707/1

(57) ABSTRACT

An apparatus for security applications, e.g., encryption. The apparatus has an interface (e.g., MAC) coupled to a fiber channel. The interface is adapted to receive a frame from the fiber channel. The apparatus also has a classifier coupled to the interface, which is adapted to determine an information type associated with the frame. The type is selected from at least an initiator, data, or terminator. The classifier is adapted to determine header information associated with the frame. A content addressable memory is coupled to the classifier.

### CROSS REFERENCES TO RELATED APPLICATION

This application claims priority to Provisional Application No. 60/419,658 filed Oct. 18, 2002, hereby incorporated by reference for all purposes.

### BACKGROUND OF THE INVENTION

The present invention generally relates to security applications. More particularly, the invention provides a method and system for security applications using an encryption/decryption process. Merely by way of example, the invention has been applied to a storage area network. But it would be recognized that the invention has a much broader range of applicability.

Traditionally encryption of data-at-rest (data stored on a media) has either not been addressed or has been addressed by encrypting data at the host (either by the application or other software). Deployment options in these approaches are daunting and complex which is contrary to the need for simple storage security strategies. For example: encryption/decryption is generally expensive and slows down the host; IT administrators are not comfortable installing new software on mission critical servers; and managing encryption keys on multiple hosts is messy, and cumbersome. These and other limitations have been described throughout the present specification and more particularly below.

From the above, it is seen that techniques for improving encryption are highly desirable.

### SUMMARY OF INVENTION

According to the present invention, techniques for computer security applications are provided. More particularly, the invention provides a method and system for security applications using an encryption/decryption process. Merely by way of example, the invention has been applied to a storage area network. But it would be recognized that the invention has a much broader range of applicability.

In a specific embodiment, the present invention provides an apparatus for security applications, e.g., encryption. The apparatus has an interface (e.g., Media Access Controller) coupled to a network carrying storage traffic. The interface is adapted to receive a frame from the fiber channel. The apparatus also has a classifier coupled to the interface, which is adapted to determine an information type associated with the frame. The type is selected from at least an initiator, data, or terminator. The classifier is adapted to determine header information associated with the frame. A content addressable memory is coupled to the classifier.

In an alternative specific embodiment, the invention includes an apparatus for security applications of storage area networks. The apparatus has an interface coupled to a network carrying storage traffic. A frame classifier is coupled to the interface. The classifier is adapted to determine an information type (e.g., initiator, data, or terminator) associated with the frame. A content addressable memory is coupled to the classifier. The content addressable memory comprises a rule portion and a flow portion. The rule portion is adapted to determine header information and command information from the initiator frame and the flow portion is adapted to provide a flow based upon the header information. A central processing unit is coupled to the classifier. An action processor is coupled to the central processing unit. A security action processor SAP is coupled to the central processing unit. Preferably, the SAP is adapted to process data block by block. An encryption/decryption processor is coupled the security action processor. Preferably, the encryption/decryption processor is also adapted to encrypt/decrypt the data block by block.

In a specific embodiment, the invention provides a method for security applications for storage area networks. The method includes receiving one or more frames at a security apparatus from a storage area network device through a fibre channel. The storage area network device is operated by client device. The client device is coupled to the storage area network device. The method includes determining a frame type of the one or more frames at the security apparatus and creating a flow process through one or more processors if the frame type of an initiator frame. The method also processes one or more subsequent frames associated with the flow process through the one or more processors at wire speed. The processing is substantially transparent to a user of the client device.

Numerous benefits exist with the present invention over conventional techniques. In a specific embodiment, the invention provides a way encrypt/decrypt data at wire speeds for data at rest security, as well as link security. The invention can also be implemented using conventional software and hardware technologies. Depending upon the embodiment, one or more of these benefits or features can be achieved. These and other benefits are described throughout the present specification and more particularly below.

The accompanying drawings, which are incorporated in and form part of the specification, illustrate embodiments of the invention and, together with the description, serves to explain the principles of the invention.

### BRIEF DESCRIPTION OF THE DRAWINGS

FIG. 1 illustrates a simplified diagram of a media encryption appliance deployment according to an embodiment of the present invention.

FIG. 2 illustrates a simplified diagram of the demands that different applications place on the storage networking infrastructure according to an embodiment of the present invention.

FIG. 3 is a simplified diagram illustrating an apparatus for data flow according to an embodiment of the present invention.

FIG. 4 is a simplified diagram of an alternative apparatus for data flow according to an embodiment of the present invention.

FIG. 5 is a simplified flow diagram of a classifier flow process according to an embodiment of the present invention.

FIG. 6 is a simplified flow diagram of a general action flow process according to an embodiment of the present invention.

FIG. 7 is a simplified flow diagram of a reorder buffer flow process according to an embodiment of the present invention.

### DETAILED DESCRIPTION OF THE INVENTION

According to the present invention, techniques for computer security applications are provided. In particular, the invention provides a method and system for security applications using an encryption/decryption process. More particularly, the invention provides a method and system for identifying storage flows (I/O's) and applies certain rules to a flow or data contained within the flow at wire speed, which is transparent to a user. Merely by way of example, the invention has been applied to a storage area network. But it would be recognized that the invention has a much broader range of applicability.

A method and apparatus for providing security of data at rest stored on a storage media and data in transit to storage media are disclosed herein. The method and apparatus are used for selectively encrypting/decrypting block data being written to/read from any storage media. Besides in band media encryption/decryption, the apparatus can also be used to provide link encryption strong access control (including SCSI command and block range control), prevent denial of service attacks in SANs, and gather I/O statistics in a fast, efficient, and flexible manner. The system may provide, for example, transparent media security in: primary storage access; backup/restore (including serverless backup) access; nearline storage environments used as a high-performance staging area for backup applications; and any block-level replication, disk-mirroring or snapshot environment.

This apparatus can be deployed to provide storage security in a manner which does not impose changes to the existing storage infrastructure.

In one embodiment, the system includes a data path appliance that operates in a transparent manner at multi gigabit speeds. This approach generally requires no changes at the host or the storage subsystem. The appliance is based on a frame by frame inspection architecture that preferably adds less than 100 microsecond latency. All frames are preferably processed at level 2 in the fibre channel storage stack (described below) or other storage protocols can also be supported.

| Storage Stack | Description of Component |
|---|---|
| Top Most Level | Upper level protocols such as SCSI and FICON |
| Level 4 | Protocol Mapping |
| Level 3 | Fibre Channel Common Services |
| Level 2 | Framing Protocols |
| Level 1 | Encode/Decode and Link Control |
| Level 0 | physical Interface |

Operation at level 2 of the storage stack provides transparency from the host and the storage subsystem. Elements which affect the flow of I/O operations or which promote unnecessary visibility of a device generally lead to compromised security and sub-optimal storage network operations.

The system further provides flexible deployment options (e.g., near server, in fabric, or near target). The system can handle multiple targets when deployed near server or in fabric. Furthermore, the system only needs to handle link level error recovery and is transparent to error recovery at all higher levels.

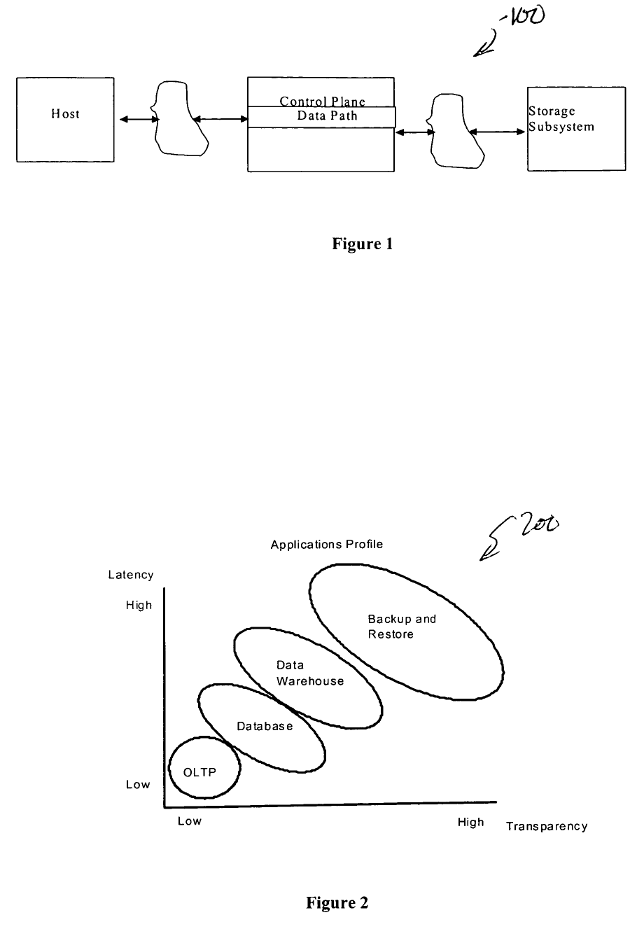

FIG. 1 illustrates one example of the deployment of a media security appliance according to an embodiment of the present invention. This diagram is merely an example, which should not unduly limit the scope of the claims herein. One of ordinary skill in the art would recognize many other variations, modifications, and alternatives. All the data frames are processed in a hardware implemented data path within the appliance. All management related functions are handled in the control plane of the appliance. As shown, the deployment includes a host system, which is coupled to a control plane/data path. The control plane/data path is coupled to a storage system. A network (see cloud) may be provided between each of these elements. Depending upon the embodiment, certain processes take place in the control plane/data path. Further details of these processes will be described in more detail throughout the present specification and more particularly below.

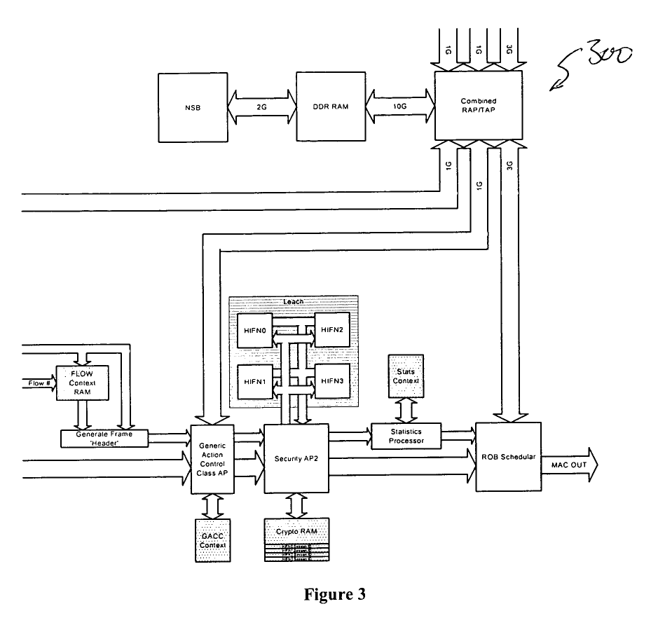

FIG. 2 illustrates a simplified diagram of demands that different applications place on the storage network infrastructure according to an embodiment of the present invention. This diagram is merely an example, which should not unduly limit the scope of the claims herein. One of ordinary skill in the art would recognize many other variations, modifications, and alternatives. The two parameters are throughput and latency. The system described herein is configured for the most stringent requirements placed by the high-end/mission-critical applications such as OLTP and databases. Other applications include data ware housing and backup and restoration. As shown, certain applications have high throughput but high latency. Other applications have low latency but low throughput. Preferably, the system can performs methods that are transparent to the end users. Here, the methods occur at wire speed.

Embodiments of the invention may include one or more of the following features:
a) selectively encrypt/decrypt data frame payloads going to/coming from the storage subsystem;
b) selectively allow or deny access to a part of the network based on deep packet inspection (down to SCSI command and block range level);
c) track individual I/Os between the server and the storage subsystem by looking at individual frames (and maintaining I/O context across a set of related frames);
d) prevent denial of service attacks on a shared storage subsystem;
e) detect intruder accesses to the shared stored storage subsystem;
f) provide the intelligence of higher layers in the storage stack while still processing frames at level 2 (in a fast hardware data path);
g) provide a flexible programmable rule based engine for block-based storage traffic in any storage network;
h) use content addressable memory (CAMs) to provide a fast lookup mechanism independent of the number of security policies and rules;
i) provide a low latency architecture for an in-band appliance that transparently encrypts/decrypts storage traffic;
j) process block level traffic for any media (disk, tapes, virtual disks, virtual tapes, etc.);
k) provide high-availability and redundancy cluster in multiple I/O paths to the same storage subsystem;
l) provide in-band authentication of the host;
m) combine link and media encryption in a single appliance;
n) allow the end user to define security policies at higher level storage objects such as volumes, partitions and drives (even though the invention operates at a block level);
o) operate in all storage networking block-level environments—fibre channel, Ethernet/IP, iSCSI, replication, backup, server less backup, snapshot, disk mirroring and any other storage network environments, etc.;
p) provide compression capabilities;
q) provide access control support;
r) provide link encryption support;
s) provide software tools for data preparation and data recovery;
t) provide support for data integrity (HMAC);
u) provide failover capability.

In one embodiment, a system is implemented in a platform as illustrated by the simplified diagram of FIG. 3. As shown, the platform is for line-rate (1G) FC frame classification and services. The services include media (e.g., data-at-rest) encryption, transport encryption (link encryption) on network storage traffic, strong access control, statistics and differentiated class of service (COS).

The platform has multiple processors (e.g., four action processors) to implement various services. Two of these, the Security Action Processors (SAP1 and SAP2) carry out Security services, namely, media encryption, transport encryption on fibre channel. The Generic Action Processor (GAP) handles frame filtering and class of service COS assignment. The Statistics processor collects statistics based on configured rules. The statistics data are periodically collected by software for export.

The platform uses a CAM-(content addressable memory) based classifier to classify frames. An incoming frame is first looked up in the flow CAM. If a match is found, the CAM index is used to lookup a flow context RAM to get the indexes of the rules that need to be applied to the frame. If the frame is a flow terminator, the flow is deleted after the frame is looked up. If a match is not found in the flow CAM and the frame is a flow initiator, a flow is automatically created and lookups are carried out on the rule CAM. The rule CAM is divided into four parts, one for each of the action processors and a lookup is done for each part. The results of the four or more rule CAM lookups are stored in the flow context RAM for further flow processing.

GAP actions can be invoked at various points in the data path. A different context RAM is associated with each invocation point.

In a specific embodiment, the platform also uses a CAM. It is configured so that one portion of the CAM is used for flows, and the other one for rules. The rule space can be divided among the different service rule groups in any manner. Priority among matches is according to physical address, with lower addresses having higher priority.

A method according to an embodiment of the present invention may be outlined as follows:
1. Provide storage traffic from a network storage environment via Fibre channel;
2. Convert the storage traffic into storage frames (e.g., header and SCSI/data);
3. Determine if the frame includes SCSI command using a classifier;
4. Look up one or more rules associated with the command;
5. Set up flow for traffic associated with the one or more rules;
6. Transfer the storage traffic with header and data to pass through the flow;
7. Implement the rule associated with the frame using one or more generic action processors (e.g., drop, pass, process); and
8. Implement the rule associated with the frame using the security processor (e.g., encrypt/decrypt or pass);
9. Implement the rule associated with the frame using the statistics processor (e.g., count);
10. Reorder the frames into a predetermined output format;
11. Convert the reordered frames into storage traffic for the network storage protocol; and
12. Transfer the storage traffic according to the output format.

Further details of the present method are described throughout the present specification and more particularly below.

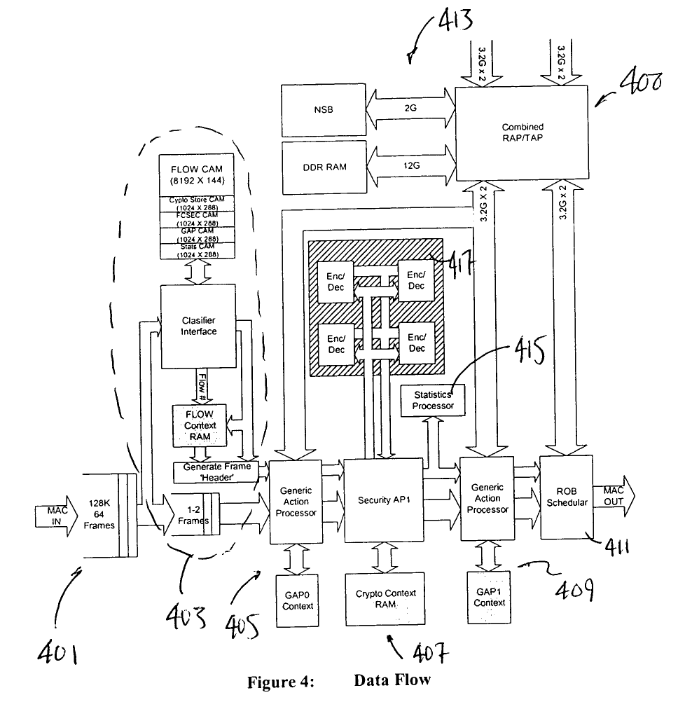

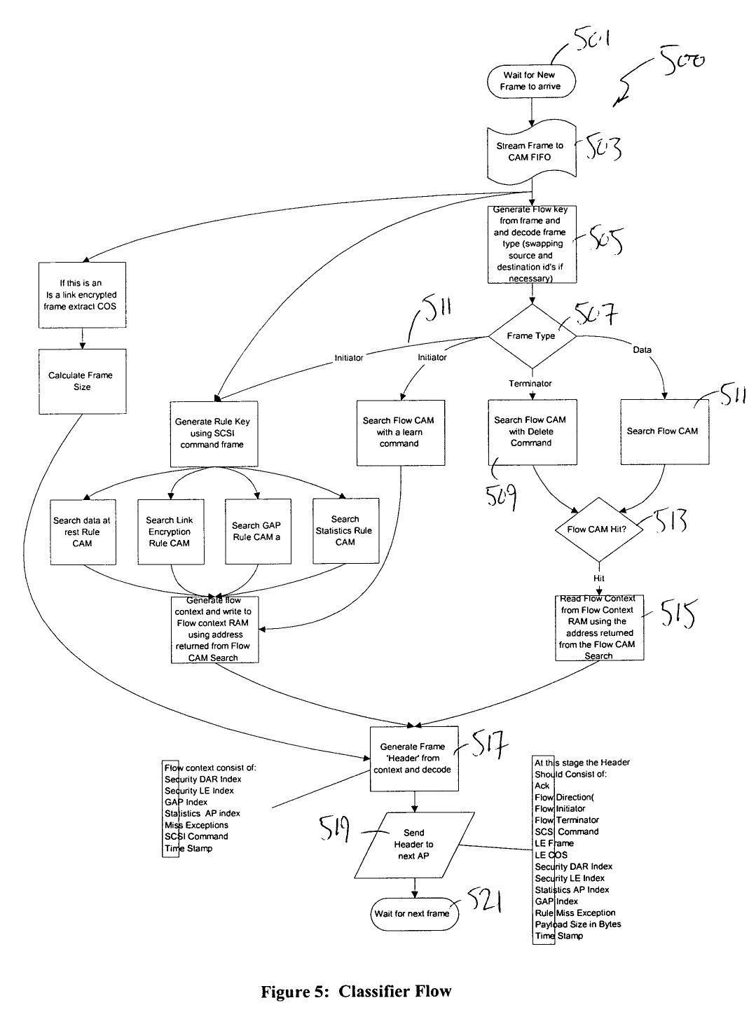

FIG. 4 is a simplified diagram of an alternative apparatus for data flow according to an embodiment of the present invention. This diagram is merely an example, which should not unduly limit the scope of the claims herein. One of ordinary skill in the art would recognize many other variations, modifications, and alternatives. As shown, the apparatus includes a variety of subsystems. The subsystems include interface, e.g., MAC. The apparatus also includes a classifier 403, which is coupled to the interface. The classifier is also coupled to a generic action processor 405. The generic action processor includes the processor itself including memory. The generic action processor couples to encryption/decryption processor 407, which includes a security processor and memory. The apparatus includes statistics processor 415, which couples between the security processor and another generic action processor 409. Depending upon the application, there can also be other generic action processors. A reorder buffer/scheduler is also included. The various processors and data flows are overseen by a central processing unit 413, which includes memory. Further details of each of these subsystems are provided in more detail throughout the present specification and more particularly below.

Preferably, the system is designed to take a stream of network storage traffic. The stream of data has a rate equivalent to the capacity of the storage network connected. The system processes the data according to rules set up in the classifier sections, which have been described. In certain embodiments, frames that cannot be classified or require software processing are passed to the CPU via the system memory and CPU interface.

In a specific embodiment, there are three action processor types available:

Generic Action Processor (GAP)

The GAP performs generic actions such as passing frames to the CPU and if required some data manipulation based on the GAP rules according to certain embodiments. Other functions are also available depending upon the embodiment.

Security Action Processor (SAP)

The SAP's are dual function and can perform data at rest or link encryption operations based on the respective classifier rules. The actually encryption/decryption is performed on the encryption engines. Such engines could also be replaced to perform different function in future. Other functions are also available depending upon the embodiment.

Statistics Action Processor

The statistics block performs statistical and timing functions based on the Stats Rules. Other functions are also available depending upon the embodiment.

The descriptions provided for each of the processors are merely examples, and should not unduly limit the scope of the claims herein. One of ordinary skill in the art would recognize other variations, modifications, and alternatives.

In an embodiment in which both data at rest and link encryption may be required for each frame these units are repeated, also the classifier needs to be repeated after an link decrypt to allow classification on clear frames.

The Reorder Buffer is required since frames may become out of order as they are bypassed through action processors, redirected for software processing or distributed to the security engines.

The present diagram shows the flow of data (the wide paths) and control for one channel (of 2) or more channels in the system. More channels can be added to the system as desired. The CPU subsystem is not shown in this diagram but does have access to the system via the CPU Interface.

Note: Areas 417 are accessible to the CPU via the CPU interface.

As noted, the system has an interface such as the MAC interface. The system can support up to a variety of configurations. In a specific embodiment, the system can support 2 Fibre Channels or 2 Gigabit Ethernet ports plus a combination of both up to a bit rate of 2 Gb/s or higher depending upon the application. To allow for stalls in the system a 128K Byte per port Frame buffer is used in certain embodiments. The MAC interfaces outputs frames associated with the incoming stream of data from the Fiber Channel or Gigabit Ethernet ports. Other interfaces, however, may also be used.

The classifier can perform five or more searches in the external CAM for each frame. Theses are split into one flow search and four or more rule searches. Depending upon the application, certain searches may be performed. Preferably, the searches performed depend upon the type of frame received. Examples of the type of frame received are as follows:

Flow Initiator Frames

The initiator frames are the first frames of an I/O flow. Preferably, the initiator frame is a SCSI command frame. Initiator frames are sent to the Flow Cam with a learn command and also to 4 or more Rule CAM's. The result of the rule CAM searches are then used to set up an entry in the flow context RAM.

Flow Terminator Frames

The terminator frames are the last frames of an I/O flow, terminator frames need to tear down a flow as they are processed. A terminator frame is sent to the Flow Cam only with a delete command. If there is a miss in the Flow CAM the rule CAM's can then be searched as well if desired, if there is a still no hits the Frame is dropped or redirected to software.

Flow Data Frames

Data frames should always hit in the Flow CAM, if there is a miss the Frame is redirected to software.

Special Frames

Some frames need to be treated as special as they have no Flow Context, these frames will need to be passed to all the CAM and if there is no hit on a flow or rule set up by software then they will be redirected for software processing. Depending upon the embodiment, any combination of these frames can also be processed. In certain embodiments, a second classify pass is required if both link and data at rest encryption is desired. Further details of a method of performed by the classifier according to an embodiment of the present invention are provided throughout the present specification and more particularly below.

FIG. 5 is a simplified flow diagram of a classifier flow process 500 according to an embodiment of the present invention. This diagram is merely an example, which should not unduly limit the scope of the claims herein. One of ordinary skill in the art would recognize many other variations, modifications, and alternatives. As shown, we have provided a brief description of the classifier processes as follows:
The process begins at step 501, which waits for the new frame to arrive. Here, the frame can be an initiator frame, a data frame, or a terminator frame, or any combination of these.
Inspect all storage frames received and determine if the frame is flow initiator (i.e. a SCSI Read or Write command), a data frame or a terminator (SCSI response frame), steps 503, 505, and 507;
Generate a flow key (step 505) from Header information;
If frame is a flow initiator, step 511:
   1. Generate Rule look up keys from Header and SCSI command information;
   2. Search Rule CAM using generated key's;
   3. Use flow key to create a new flow entry;
   4. Create flow context entry using rule search results new flow index;
If frame is a flow terminator or data frame, steps 509 and 511:
   1. Search Flow CAM using flow key, step 511;
   2. Read flow context entry indicated by flow search result, step 515;
Attach flow context information to frame and pass on to GAP, steps 517 and 519;
Wait for next frame, step 521.

The above sequence of steps are merely examples, which should not limit the scope of the claims herein. One of ordinary skill in the art would recognize many variations, alternatives, and modifications.

In a specific embodiment, the present system includes one or more GAPs. The GAP may have a variety of functions. Preferably, the function includes to control the Frame flow depending on the GAP rules. There are a variety of possible actions that have to be done. Actions are controlled by GAP context RAM using the classifier rule index assigned to the frame for GAP actions. Certain actions have been listed below.

Drop Frame
Stop frame from being passed to the next action processor.

Forward Frame
Allow frame to pass.

Copy Frame
Allow frame to pass and also send a copy to the CPU

Redirect Frame
Send frame to CPU for processing (frame will be returned when processing is complete).

Skip Frame
Send frame to CPU and stop frame from being passed to the next action processor.

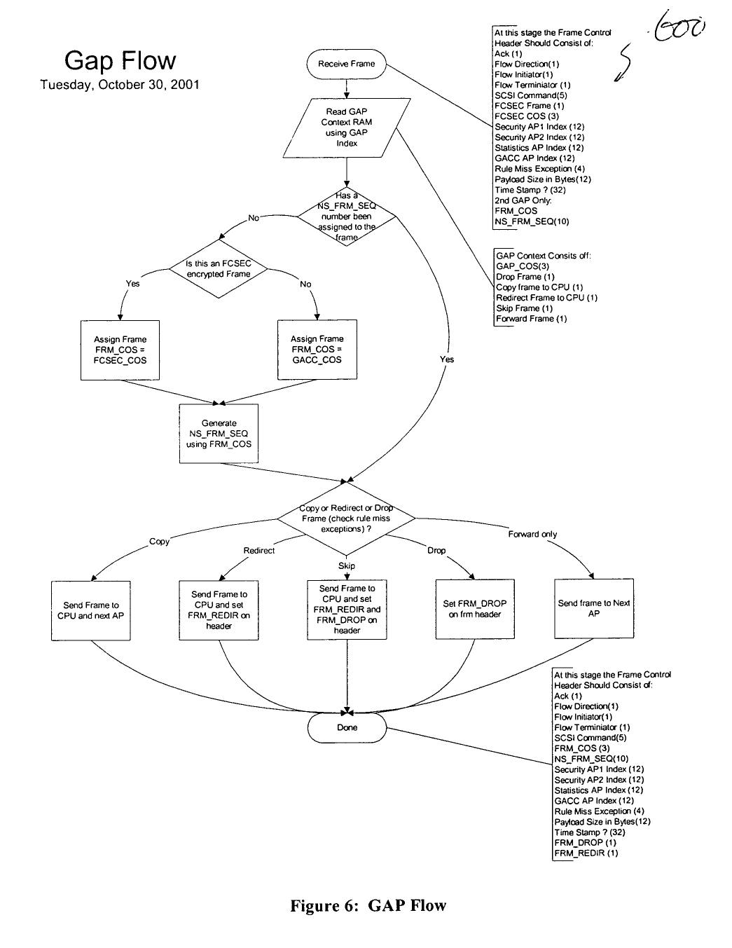

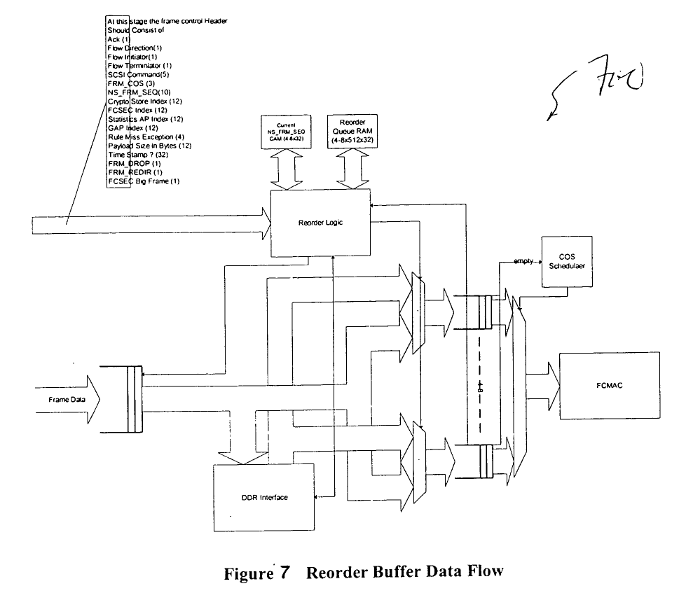

The first of the GAP's is also used to assign sequence numbers to the frames for the use of the reorder buffer at a latter stage. As merely an example, further details of a method using the GAP is illustrated by the simplified diagram 600 in FIG. 6.

In a specific embodiment, the system includes one or more security action processors, i.e., SAPs. The SAPs perform the desired encryption/decryption operations using the rule indices provided by the classifier, this can be either for data at rest or link encryption purposes. The following steps are performed by the SAP in this specific embodiment of the present invention:
1. Receive and store frame from GAP
2. Read Crypto Context Ram using rule index assigned by classifier to obtain encryption parameters and actions to be taken.
3. For data at rest operations, split data frames into blocks of the size specified in the crypto context ram and calculate crypto initialization vector).
4. Send data blocks or entire frame (for link encryption operations) to the crypto engines.

When data is returned from encryption engines, reassemble frame and send to next GAP. Depending upon the embodiment, there can be other variations, modifications, and alternatives.

In a specific embodiment, the system includes one ROB per data stream (input port to output port). Preferably, the ROB reorders the frames into the same order as they where received by the system. In some cases class of service rules are enacted by the ROB to allow specified frames to bypass others if allowable. The ROB performs the following steps to achieve the reordering of frames:
1. Receive frame and extract sequence number and COS (class of service) of the frame.
2. If frame is the next to be transmitted pass to the MAC for transmission.
3. If frame is not the next to be transmitted send to memory until all other frames with lower sequence numbers have been transmitted.
4. If a stored frame's sequence number is the next to be transmitted, retrieve frame and send to MAC.

FIG. 7 is a simplified flow diagram of a reorder buffer flow process 700 according to an embodiment of the present invention.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

1. Apparatus for security applications, the apparatus comprising:
an interface coupled to a storage network, the interface being adapted to receive a frame from the storage network;
a classifier coupled to the interface, the classifier being adapted to determine an information type associated with the frame, the type being an initiator, data, or terminator, the classifier being adapted to determine header information associated with the frame; and
a content addressable memory coupled to the classifier.

2. Apparatus of claim 1 wherein the content addressable memory comprises a rule portion and a flow portion, the rule portion being adapted to determine header information and command information from the initiator frame and the flow portion being adapted to provide a flow based upon the header information.

3. Apparatus of claim 1 further comprising:
a central processing unit coupled to the classifier;
an action processor coupled to the central processing unit;
a security action processor SAP processor coupled to the central processing unit, the SAP being adapted to process data block by block; and
an encryption/decryption processor coupled the security action processor, the encryption/decryption processing being adapted to encrypt/decrypt the data block by block.

4. Apparatus of claim 1 wherein the initiator determines a read or a write process.

5. Apparatus of claim 1 wherein the content addressable memory comprises at least two MBit.

6. Apparatus of claim 1 wherein the interface is adapted to receive the frame through the fiber channel in a SCSI format.

7. Apparatus of claim 1 wherein the frame is associated with a SCSI frame format.

8. Apparatus of claim 1 wherein the classifier is provided on an integrated circuit chip.

9. Apparatus of claim 1 wherein the classifier is adapted to maintain wire speed operation while determining the information type and header information associated with the frame.

10. Apparatus of claim 1 further comprising a flow context random access memory coupled to the classifier, the flow context random access memory being adapted to store a policy based upon a flow, the flow being associated with the header information.

11. Apparatus of claim 1 wherein the classifier is used in determining access controls to target volumes & partitions.

12. Apparatus of claim 1 wherein the classifier is used in allowing access to specific targets only to authenticated hosts and, in some scenarios applications running on the hosts.

13. Apparatus of claim 1 wherein the aparatus is operable in a NULL port in a storage area network.

14. Apparatus for security applications of storage area networks, the apparatus comprising:
an interface coupled to a storage network, the interface being adapted to receive a frame from the storage network;
a classifier coupled to the interface, the classifier being adapted to determine an information type associated with the frame, the type being an initiator, data, or terminator, the classifier being adapted to determine header information associated with the frame; and
a content addressable memory coupled to the classifier, the content addressable memory comprises a rule portion and a flow portion, the rule portion being adapted to determine header information and command information from the initiator frame and the flow portion being adapted to provide a flow based upon the header information;
a central processing unit coupled to the classifier;
an action processor coupled to the central processing unit;
a security action processor SAP processor coupled to the central processing unit, the SAP being adapted to process data block by block; and
an encryption/decryption processor coupled the security action processor, the encryption/decryption processor being adapted to encrypt/decrypt the data block by block.

15. Apparatus of claim 14 wherein the initiator determines a read or a write process.

16. Apparatus of claim 14 wherein the content addressable memory comprises at least two MBit.

17. Apparatus of claim 14 wherein the interface is adapted to receive the frame through the fiber channel in a SCSI format.

18. Apparatus of claim 14 wherein the frame is associated with a SCSI frame format.

19. Apparatus of claim 14 wherein the classifier is provided on an integrated circuit chip.

20. Apparatus of claim 14 wherein the classifier is adapted to maintain wire speed operation while determining the information type and header information associated with the frame.

21. Apparatus of claim 14 further comprising a flow context random access memory coupled to the classifier, the flow context random access memory being adapted to store a policy based upon a flow, the flow being associated with the header information.

22. Apparatus of claim 14 wherein the apparatus is not a switch or a router or a virtualization device.

23. Apparatus of claim 22 wherein the apparatus further comprises a switch or a router or a virtualization device.

24. A method for security applications for storage area networks, the method comprising:
receiving one or more frames at a security apparatus from a storage area network device through a fibre channel, the storage area network device being operated by client device, the client device being coupled to the storage area network device;
determining a frame type of the one or more frames at the security apparatus;
creating a flow process through one or more processors if the frame type of an initiator frame;
processing one or more subsequent frames associated with the flow process through the one or more processors at wire speed;
whereupon the processing is substantially transparent to a user of the client device.
